(19) United States
(12) Patent Application Publication
(10) Pub. No.: US 2012/0251663 A1
(43) Pub. Date: Oct. 4, 2012

(54) DOUGH TARGETING FOR ENHANCED MICROWAVE REHEATING

(75) Inventors: Timothy George Prins, Solon, OH (US); Urban Nilsson, Aurora, OH (US)

(73) Assignee: NESTEC S.A., Vevey (CH)

(21) Appl. No.: 13/516,035

(22) PCT Filed: Oct. 25, 2010
(86) PCT No.: PCT/EP2010/066059

§ 371 Date: Jun. 14, 2012

Related U.S. Application Data
(60) Provisional application No. 61/287,416, filed on Dec. 17, 2009.

(51) Int. Cl. A21D 8/02; A21D 6/00; A21D 10/02; A21D 8/04; A23P 1/12; A23L 1/025

(52) U.S. Cl. 426/19; 426/549; 426/61; 426/243

(57) ABSTRACT

The invention relates to a method of improving the organoleptic properties of a baked dough product which is to be reheated with microwaves, by targeting and positioning first and second dough portions in the dough product that respond differently to microwave reheating after baking to achieve optimal consumer experience and quality benefits. The baked dough product obtainable by the method is another embodiment of the invention.

### FIELD OF INVENTION

The invention is directed to a dough product having two or more completely different dough types strategically placed or positioned in the dough product to enhance the organoleptic properties of the dough product after baking and subsequent reheating in the microwave oven.

### BACKGROUND OF THE INVENTION

Pre-baked, microwaveable frozen bakery dough products have become increasingly popular as they require minimal preparation immediately prior to serving. However, due to different heating profiles of microwave and conventional ovens, challenge remains to achieve desirable organoleptic properties after reheating the bakery product in the microwave oven. In conventional oven, the heating profile is from outside in, such that the crust is the hottest part and the center is the coolest. In contrast, in microwave oven, the heating of food products is random and throughout the entire product such that the interior or high moisture areas of the dough product absorbs the microwaves and transforms them into heat, leading to a reversed heating profile that often makes the exterior the coolest part due to evaporative cooling. As a consequence, high energy heating zones occur that diminishes the traditional consumer expectations of the product and results in a product, such as a pizza or a Panini, with soggy interior and hard and tough crust.

US patent application publication no. 2005/0025862 to Morad et al. discloses a bakery dough product with a two dimensional structure comprising multiple layers that can be baked in the microwave oven into a unique structure having a soft moist interior region and a crispy, flaky exterior region. This demonstrates that conventional dough products need to be modified to improve its resultant properties achieved conventional or microwave baking.

In particular, however, there remains a need in the industry to improve the texture, taste, appearance, nutrition, color, and flavor of dough products that are initially baked and then subjected to microwave reheating. The present invention satisfies this need of the industry by using one or more of various dough types to target specific locations or positions in dough products to achieve optimal consumer experience and quality benefits, especially when the baked dough product is subjected to reheating in a microwave oven.

### SUMMARY OF THE INVENTION

The present invention relates to a method of improving the organoleptic properties of a baked dough product which is to be reheated with microwaves. The method includes selecting first and second bakery dough portions that are sufficiently viscous to inhibit or avoid miscibility thereof when placed in contact prior to baking, and having properties such that, after being baked, the first bakery dough portion responds differently to microwave reheating compared to the second bakery dough portion; providing at least one of the first or second dough portions with a leavening agent and requiring proofing of that dough portion prior to baking; associating at least a part of the first bakery dough portion with the second bakery dough portion in an unbaked configuration with the dough portions targeted and positioned to provide an improved response of the baked product to microwave reheating; baking the bakery dough portions in a conventional oven to obtain a bakery dough product; and packaging the bakery dough product for transport and sale. The final bakery dough product, after being baked, is optimally reheated when subjected to heating in a microwave oven due to the differences in responses to microwave heating of the baked dough portions to thus obtain a baked and reheated dough product for consumption with the product having desired organoleptic properties compared to dough products that do not utilize such targeted and positioned first and second bakery dough portions.

In an embodiment, the method of the invention further comprises co-extruding the first and second bakery dough portions so that the second dough portion surrounds the first dough portion. Alternatively, the method further comprises sheeting the first bakery dough portion and placing the second bakery dough portion upon, adjacent to, or at a specific location to the sheeted first dough portion.

Depending upon the packaging materials, the final dough product can either be removed from the package and reheated in a microwave oven, or it can be reheated in the package and then is removed from the package for consumption.

In another embodiment, the method further comprises forming the first bakery dough portion in a generally flat shape having an edge along its perimeter; and arranging the second dough portion to surround at least a portion of the edge of the first bakery dough portion. For example, the first bakery dough portion can be formed in a substantially circular or rectangular shape while the second dough portion provides a contiguous band in contact with the edge. In particular, the dough product can be a pizza dough with the first bakery dough portion forming a center portion of the pizza dough and the second bakery dough portion forming a perimeter of the pizza dough. Thereby, the crust has a desired texture after being reheated in the microwave oven.

In another embodiment, the method of the invention further comprises forming the first bakery dough portion into a mass having a generally circular, oval, crescent, or polygonal cross-sectional shape; and substantially enclosing the first bakery dough portion with the second bakery dough portion. As an example, the first bakery dough portion may have a substantially cylindrical shape and the second bakery dough portion envelops the first bakery dough portion. The cylinder may then be cut to create bread slices with desired outer and inner texture after being reheated in the microwave oven.

In yet another embodiment, the method of the invention further comprises providing a third bakery dough portion that includes a leavening agent and that requires proofing prior to baking, with the third bakery dough portion being sufficiently viscous to inhibit or avoid miscibility with the first and second bakery dough portions when in contact therewith, providing the third bakery dough portion with properties such that, after being baked and subjected to microwave reheating, the third bakery dough portion responds differently to microwave reheating compared to the first and second bakery dough portions; and arranging the third bakery dough portion to surround at least a part of the first or second bakery dough portion to form the unbaked configuration for simultaneous baking of the first, second, and third bakery dough portions. As one example, the unbaked configuration can be provided by (i) forming the first bakery dough portion into a generally polygonal shape having sides and corners; (ii) placing the second dough portion along the sides of the polygonal shape between the corners; and (iii) arranging the third bakery dough adjacent the corners of the polygonal shape. As another example, the unbaked configuration is provided by (i) forming the first bakery dough portion into a mass having a generally circular, oval, crescent, or polygonal cross section having an outer surface; (ii) placing the second dough portion to surround part of the outer surface of the mass; and (iii) placing the third dough portion to surround a remaining part of the outer surface of the mass, such that the second and third bakery dough portions together enclose the first bakery dough portion.

In yet another embodiment, the method of the invention further comprises enclosing a filling such as a meat, chicken, fish, starch, vegetable, nuts, dairy, sauce, spice, or combinations thereof within the first and second bakery dough portions.

In yet another embodiment of the method of the invention, the first bakery dough portion may be formulated to be softer than the second bakery dough portion after being baked and subjected to microwave reheating. Alternatively, the first bakery dough portion can be formulated to accept moisture migration without becoming gummy after being baked and subjected to microwave reheating while the second bakery dough portion is formulated to prevent hardening and toughening after being baked and subjected to microwave reheating. In a particular embodiment, the first and second bakery dough portions can be bread doughs with the second dough portion formulated so as to not form a crust after being baked and subjected to microwave reheating, such that the final bakery product forms a crustless bread after being baked and subjected to microwave reheating.

In other embodiments, the first or second bakery dough portion can include one or more of a flour, grain, flavoring agent, coloring agent, textural agent, fiber, and nutrient additive that is not included in the other bakery dough portion. If desired or necessary, a predetermined pattern can be formed with the first and second bakery dough portions.

The invention also relates to a microwaveable dough product produced by the method of the invention. This product includes first and second bakery dough portions that are sufficiently viscous to inhibit or avoid miscibility thereof when in contact prior to baking, but that have properties after baking such that the first bakery dough portion responds differently to microwave heating compared to the second bakery dough portion. At least one of the first or second dough portions includes a leavening agent and was proofed prior to baking, with at least a part of the first bakery dough portion associated with the second bakery dough portion and being targeted and positioned to provide an improved response of the baked dough product to microwave heating. This baked dough product after being heated in a microwave oven is optimally reheated due to the differences in responses to microwave heating of the baked dough portions to obtain a baked and reheated dough product for consumption having desired organoleptic properties compared to dough products that do not utilize such targeted and positioned first and second bakery dough portions.

The invention also relates to the use of first and second bakery dough portions that have different responses to microwave heating in a bakery dough product that is baked and then is to be subjected to microwave reheating, wherein the dough portions are targeted and positioned to provide an improved response of the baked dough product to microwave heating to obtain a baked and reheated dough product for consumption having desired organoleptic properties compared to dough products that do not utilize such targeted and positioned first and second bakery dough portions. As noted above, at least one of the first or second dough portions includes a leavening agent and was proofed prior to baking, and wherein the baked dough product after being heated in a microwave oven is uniformly reheated due to the differences in responses to microwave heating of the baked dough portions.

### BRIEF DESCRIPTION OF THE DRAWINGS

The invention will be better understood in relation to the attached drawings illustrating preferred embodiments, wherein:

FIGS. 1A, B and C show cross-sectional views of three different Panini embodiments of the invention with the fat arrows indicating inner dough portions and the thin arrows indicating outer dough portions;

FIGS. 2A and B show round (A) and square (B) pizza embodiments of the invention while FIG. 2C shows a French bread pizza embodiment of the invention with the fat arrows indicating inner dough portions and the thin arrows indicating outer dough portions;

FIG. 3 shows top and side views of pita and quesadilla products of the invention with the fat arrow indicating the inner dough portion and the thin arrow indicating the outer dough portion; and

FIGS. 4A, B and C show three different embodiments of Nestle' HOT POCKETS® sandwich products.

FIGS. 5A and B show the production process of a co-extruded two-formula dough (A) and the cross-section of a slice of bread made from such a dough (B).

FIG. 6 shows the equipment (Instron) and process of measuring bread toughness.

FIG. 7 is a diagram showing different locations on a slice of bread where the measurement of toughness is taken.

FIG. 8 shows the average load (N) required to penetrate the bread slice at the given speed as a function of the penetration. The three upper curves refer to the crust parts, and the lower three curves refer to the center parts.

FIGS. 9A-D show that the inner dough formulation spreads significantly when baked unrestricted (FIGS. 9C and D) while the co-extruded cookie was restricted from excessive expansion by the low expansion of the outer dough (FIGS. 9A and B).

### DETAILED DESCRIPTION OF THE PREFERRED EMBODIMENTS

The present invention relates to a method of improving the organoleptic properties of a baked dough product which is to be reheated with microwaves by strategically targeting or positioning two or more completely different dough types in the product to provide certain attributes to the product that can be enjoyed by the consumer after the product is reheated in the microwave. The dough type differences can be in the form of dough formulation, dough mixing, or dough manufacturing or mixing technologies. The dough targeting method of the invention makes it possible to deliver the relevant texture, taste, appearance, color, flavor, and nutrition element, or a combination thereof, to the proper location in the microwaveable product, which cannot be accomplished in dough products made of a single bakery dough or a single formulation alone due to the unique heating method of microwave ovens.

The invention also relates to a microwave product produced by the method of the invention having two or more completely different dough types strategically targeted or positioned in the product to form a three dimensional structure and to provide certain attributes to the product that can be enjoyed by the consumer after the baked product is reheated in the microwave. The baked dough product after being reheated in a microwave oven is not uniformly reheated yet obtains the uniform organoleptic properties compared to dough products that do not utilize such first and second bakery dough portions. Thus, the differences between the first and second dough portions may not be noticed by the consumer because the product has a uniform feature after reheating in the microwave oven. In contrast, when a single dough formulation is used, the edges, corners and crust of the dough product would be harder than the remainder of the product, and are not as desirable for consumption.

The first or second bakery dough portion typically includes one or more of a flour, grain, flavoring agent, coloring agent, textural agent, fiber, and nutrient additive that are not included in the other bakery dough portion. The flour content is generally about 30% to 65%, preferably about 40% to 60%, and more preferably about 45% to 55% by weight. Preferably, the texturing agent is egg or egg white. The flavoring agent may be natural or artificial and when included is typically present in an amount of about 0% to 5%, preferably about 0% to 1% by weight.

In yet another embodiment, the first bakery dough portion can be a laminated dough formulated to provide a light and tender crust, and the second bakery dough portion is a non-laminated dough formulated to provide a firm and rigid crust after reheating in a microwave oven.

Co-extrusion of the dough portions can be achieved by using commercially available extruders such as those from Rheon Automatic Machinery Company, Ltd. of Utsunomiya (Japan), Hosokawa Bepex GmbH of Leingarten (Germany), SASIB of Plano (Texas), APV Systems of Rosemont (Illinois), Aasted-Mikroverk Bakery Equipment of Farum (Denmark) and others.

In one embodiment, the dough is prepared as a chub pack, a cylindrical or sausage-shaped form. In this form, the center portion of the dough product has a diameter of about 1 to 3 inches and the width of the edge portion is about 0.1 to 1 inch. Preferably, the center portion of the dough product has a diameter of about 1 to 2.5 inches. In one most preferred embodiment, the center portion of the dough product has a diameter of about 1 to 2 inches and the width of the edge portion is about 0.5 to 1 inch.

In another embodiment, the dough product is shaped in the form of a block having a square, rectangular, triangular, oval, or other cross-sectional configuration so that the baked products have a circular or round baked periphery. The dough is generally cut into smaller pieces prior to baking.

Specific examples of the microwaveable products of the invention include, but are not limited to, STOUFFER'S®, LEANCUISINE® and Panini bread slices; flatbreads such as flatbreads, pitas and quesadillas; round, square and rectangle pizzas; French bread pizza; and HOT POCKETS® sandwiches. The microwave dough product of the invention may be a pizza or Panini with a different dough type on the outside of the crust than the inside of the crust. The consumer may or may not recognize that there are two different dough types being used, but they will notice the superior quality of a product made utilizing dough targeting. In addition, dough targeting of the invention can also be used to achieve other benefits such as nutritional delivery.

The dough product may be refrigerated or frozen after baking in the conventional oven. Typically, the product is refrigerated at a temperature of less than about 50° F. (10° C.), preferably about 32° F. to 40° F. (0° C. to 4.5° C.) for storage or display before reheating in the microwave oven.

The different dough portions can be obtained in a number of ways by which a skilled artisan is generally familiar. Different flour or flour combinations can be used. Typically, wheat flour is used, but different types and combinations of wheat flour can be used to achieve different responses to microwave reheating of baked dough.

Many other types of flour can be used alone or in combination to provide baked doughs that have different responses to microwave reheating. These include amaranth flour, bean flour, white or brown rice flour, buckwheat flour, chestnut flour, chickpea flour, potato flour, corn flour, nut flour grated from oily nuts, pea flour, peanut flour, rye flour, tapioca flour, or soy bean flour. Flour can also be made from arrowroot, taro, cattails, acorns, quinoa, seeds and the like. The skilled artisan can best determine any particular flour formulation and its response to microwave heating by preparing the formulation, baking it conventionally and then subjecting it to reheating in a microwave oven. As the products of the invention use multiple dough portions, the product can be made using two, three, four or even more different dough portions, then baked and finally reheated to measure the relative performance of the different baked dough portions. The examples illustrate some preferred combinations.

Another way to achieve the desired effect of different response to microwave heating is to control the moisture content of the dough portions while still accounting for moisture migration to occur. This can be done by simply varying the amount of water in the formulation, or by providing additives in the dough that retain water. Adding fiber, for example, is one way to do this. Fiber can be added to one of the dough portions, or different fibers can be added to different dough portions. Dietary fibers are typically soluble or insoluble. Soluble fibers are found in varying quantities in all plant foods, including legumes (peas, soybeans, and other beans), oats, rye, chia, and barley, certain fruits and fruit juices (including prune juice, plums, berries, bananas, and the insides of apples and pears), certain vegetables such as broccoli, carrots and Jerusalem artichokes, roots such as potatoes, sweet potatoes, and onions, and psyllium seed husk. Sources of insoluble fiber include whole grain foods, wheat and corn bran, nuts and seeds, potato skins, flax seed, lignans, certain vegetables such as green beans, cauliflower, zucchini (courgette), celery, and nopal, and the skins of certain fruits, such as tomatoes. The amounts and/or types of fiber can be added to the dough portions to obtain different responses to microwave heating, and thus desired dough texture after heating.

Another type of additive to include in the dough portions is a conventional product known as Micro Sure 2.5, which is available from Caravan Ingredients of Lenexa (Kansas). Micro Sure 2.5 is a combination of dough improvers including wheat gluten, oat fiber, sodium stearoyl lactylate, monoglycerides, guar gum, algin, xanthan gum and enzymes.

Doughs may also be modified through use of different flour types such as rye, hard or soft wheats, tricale, barley, oat, corn, quinoa, spelt, buckwheat, rice, kamut, or amaranth.

Another embodiment of the invention is to combine different doughs for spread control for a microwave cooked cookie. A cookie dough formulated to give increased softness/moistness typically spreads more due to higher water content and the presence of emulsifiers, humectants such as sugars. In microwave baking this can be an issue. To solve this issue, two formulations of the inner and outer doughs are used to make coextruded dough. The inner dough remains soft when heated in the microwave while the outer dough is firmer and is resistant to spread when heated in the microwave. The two formulations are different because the addition of the dough modifiers to one single dough mix would not create the desired final result of a microwave heated cookie with a firmer exterior and a softer interior.

Another way that doughs can be modified or formulated so that they provide difference microwave reheating performance is to change fat content of the doughs. For example, increased fat content can make bread or pizza dough tenderer. Such a dough formulation can be used to constitute areas in a product that otherwise would be too chewy or tough.

Yet another group of functional ingredients that can modify microwave reheating performance are enzymes, notably proteases. These enzymes act by weakening the gluten structure and hereby reducing the tendency of the reheated dough to become tough. Again, such a dough formulation can be used in parts of a product that otherwise would become tough.

### EXAMPLES

The examples that follow illustrate various preferred ways for formulating different dough portions for targeting and positioning in bakery products to achieve the benefits of the invention.

### Dough Targeting to Panini Products (Co-extruded or Handmade)

To deliver nutritional benefits, the inner dough is made from whole wheat. Due to the masking effects of the filling or topping in this location, the nutritional benefits of the whole grain can be delivered without the whole wheat or whole grain flavor.

To enhance the microwave reheating properties of the Panini, the inner dough is designed to adapt to topping or filling moisture migration without becoming gummy during microwave heating. Additionally, the outer dough is designed to prevent hardening and toughening during microwave heating, which is a common issue during microwave reheating of dough products.

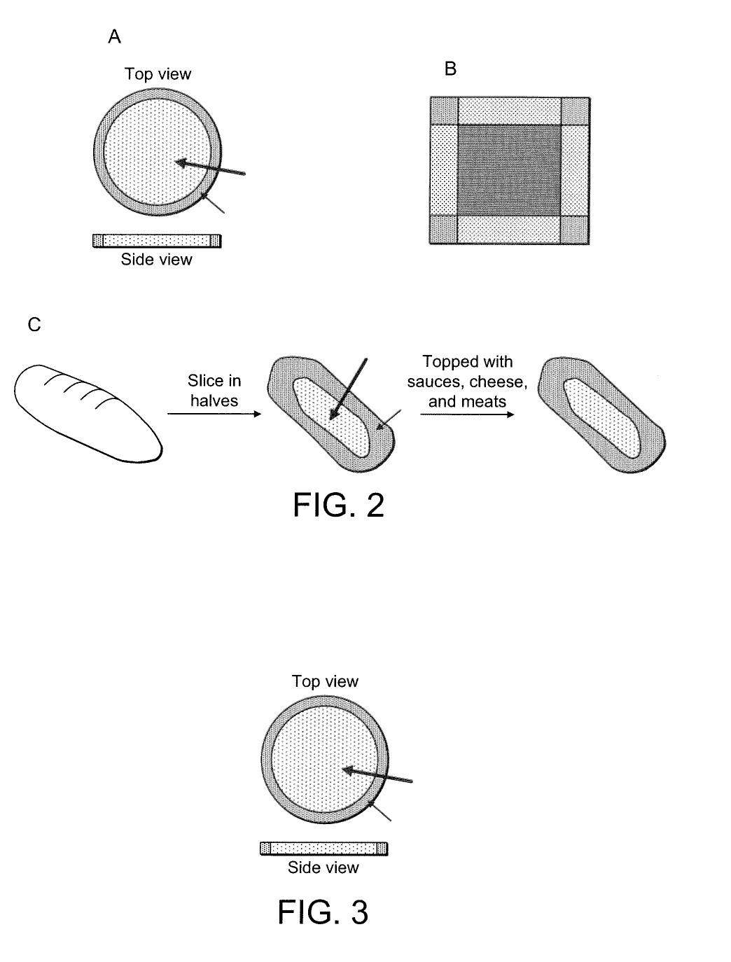

As shown in FIG. 2B, the inner dough can be made from white Italian wheat while the outer dough imparts a crustless characteristic, which is especially desirable for children.

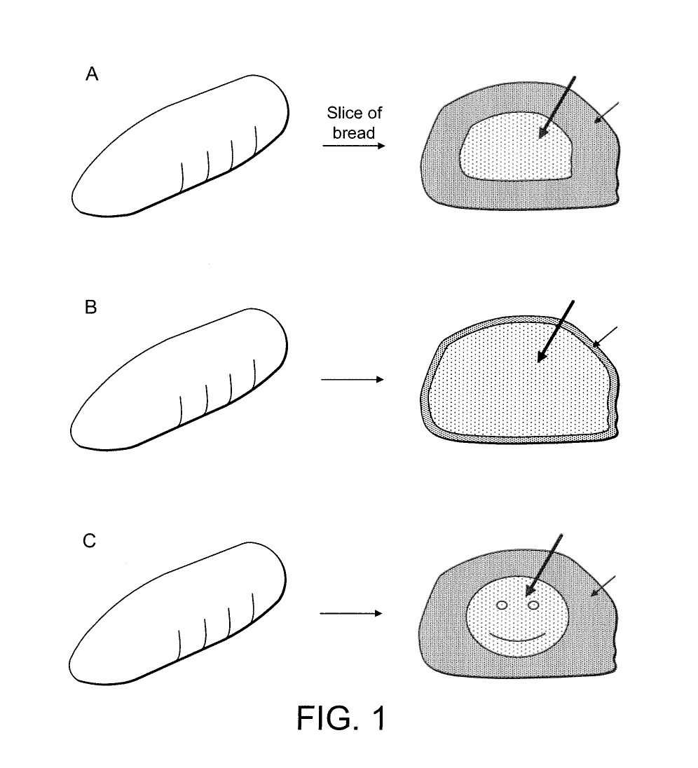

As shown in FIG. 1C, color and appearance benefits such as a happy face design can be achieved by formulating the inner dough as colored white bread and the outer dough as whole wheat bread to represent hair appearance.

When the outer dough is made from butter, salty or garlic bread, flavor benefits can be achieved by adding to the experience of the filling to the edge of the bread slice.

### Dough Targeting to Round, Square, and Rectangle Pizza Products (Co-Extruded, Sheeted or Handmade) and French Bread Pizza Products (Co-extruded or Handmade)

To enhance the microwave reheating properties of the dough product, the inner dough is designed to adapt to topping or filling moisture migration without becoming gummy and soggy during microwave heating while the outer dough, which forms the ring or edge in rectangle or square shaped pizza, is designed to prevent hardening and toughening during microwaving. A further improvement can be achieved by using a third different type of dough at the corners of the square and rectangle pizzas to prevent hardening and toughening of the corners, where a lot of microwave energy are localized (FIG. 2B). The corner dough portion is formulated to adapt to perform with moisture migration while the edge dough portion has a medium level of moisture retention.

In the case of a round pizza, the inner and outer dough portions are arranged in concentric circles with the inner circle being 4.5 inches in radius and the outer circle being 1.5 inches in thickness, forming a rod shaped block. Each pizza piece is sliced off the rod, laid down in a pan, hammered to flatten if necessary, let to rise for a predetermined amount of time and baked in the conventional oven. Afterwards, the prebaked pizza is frozen and packaged.

To deliver nutritional benefits, the inner dough is made from whole wheat. Due to the masking effects of the topping in this location, the nutritional benefits of the whole grain can be delivered without the whole wheat or whole grain flavor. The outer dough is formulated as traditional pizza dough formulated with oat fiber to enhance microwave performance.

Texture benefits can be achieved by formulating the inner dough to adapt to topping or filling moisture migration without becoming gummy during microwave heating or conventional heating. Additionally, the outer dough may have inclusions such as herbs and sun-dried tomatoes to improve the color and appearance of the pizza product. To enhance the flavor of the pizza, the outer dough can be formulated as butter, salty, or garlic flavor bread to add to the experience of the filling to the edge of the bread slice.

### Dough Targeting to Pitas and Quesadilla Products

To enhance the microwave reheating properties of the pitas and quesadilla products as shown in FIG. 3, the inner dough is formulated to adapt to topping or filling moisture migration without becoming gummy during microwave heating while the outer dough is formulated to prevent hardening and toughening during microwave heating.

To improve the nutritional values of these products, the inner dough is made from whole wheat with the whole wheat or whole grain flavor being masked by the filling or topping in this location.

The texture, color and browning of the inner and outer dough portions can be optimized for reconstitution, respectively. Based on consumer preferences, the inner dough can be formulated with enhanced flavor while the outer dough is formulated as butter, salty, or garlic flavor bread to add to the experience of the filling to the edge of the bread slice.

### Dough Targeting to Nestle's HOT POCKET® Sandwich Products (Sheeting or Handmade)

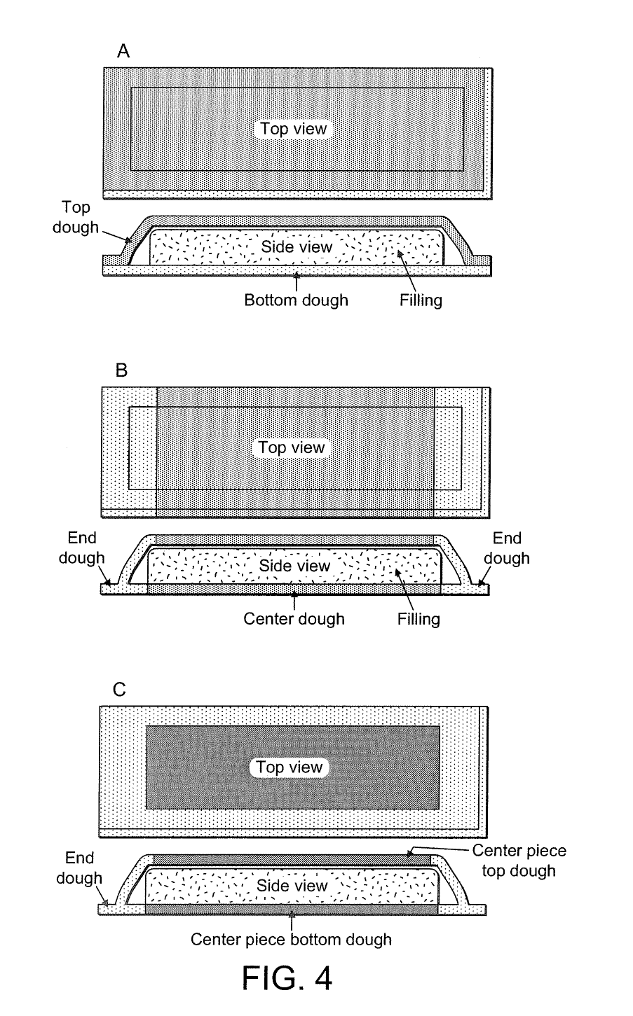

Nestle's HOT POCKET® sandwich as shown in FIG. 4A consists of a dual texture dough with the bottom dough portion being a different type than the top dough portion. The filling can be any filling ranging from Ham and Cheese to Pepperoni Pizza.

To deliver nutritional benefits, the bottom dough portion is made from whole wheat and/or with added fiber. Due to the masking effects of the filling or browning of the bottom crust at this location, the whole wheat or added fiber is delivered without the whole wheat or whole grain flavor.

To improve microwave reheating properties, the top dough portion is formulated to provide additional crispness and tenderness during microwave heating while the bottom dough portion is formulated to adapt to filling moisture migration without becoming gummy during microwave heating. A higher impact and potential cost savings can be achieved by specially formulating the top dough portion to emit flavors without changing the formulation of the bottom dough portion. Additionally, to achieve color and appearance benefits, the top dough portion can have reduced sugar for better baking and browning while bottom dough portion can be formulated for firmness, rigidity and baking optimization.

Texture benefits can also be achieved by formulating the top dough portion as laminated, light and tender top crust while formulating the bottom dough as non-laminated, firm and rigid bottom crust.

Nestle's HOT POCKET® sandwich as shown in FIG. 4B consists of a dual texture dough with the ends of the sandwich having a different dough than the middle.

To improve microwave reheating properties, the end dough is formulated to resist or decrease hardening during reheating in the microwave oven to solve the common problem of rectangular shaped products due to the high concentration of microwave energy in the ends of the sandwiches. The middle dough is also formulated to prevent hardening and toughening during microwaving.

To convey texture benefits, the end and middle dough portions are formulated for texture optimization according to proximity to filling, respectively.

The end dough portion usually has the color of white bread while the middle dough portion is formulated to produce a different color than the end dough portion. The color differences between the middle and end dough portions may be enhanced by coloring agents such as lactose.

Nestle's HOT POCKET® sandwich as shown in FIG. 4C consists of three different textured dough portions, namely the center piece top dough portion, the center piece bottom dough portion and the end dough portion. Positioning or targeting different dough potions in different locations provides the avenue to improve microwave performance of the dough product by eliminating both hard edge and corners, thus providing the consumer with a much better eating experience.

### Co-Extruded Two-Formula Bread

A bread loaf was made out of two different dough formulations (Table 1). The inner part had a whole grain flour percentage of 30% (referred to as the “inner dough” or “formula 1”) while the outer part had 100% white wheat flour and also bread improvers to reduce toughening during microwave reheating (referred to as “outer dough” or “formula 2”). These samples were referred to as “combined dough.” Samples were also made out of either just formula 1 or just formula 2.

TABLE 1
Dough Formulations

| | Formula 1 | Formula 2 |
|---|---|---|
| | (inner dough) % | (outer dough) % |
| Yeast | 0.2 | 0.2 |
| Flour wheat bleached enriched | 40 | 54 |
| malted | | |
| Flour Whole Wheat Durum Millers | 16 | 0 |
| Fresco | | |
| Oat Fiber | 3 | 3 |
| Micro Sure 2.5 | 0 | 1.33 |
| Other conventional dough additives | 4 | 4 |
| Water | balance | balance |

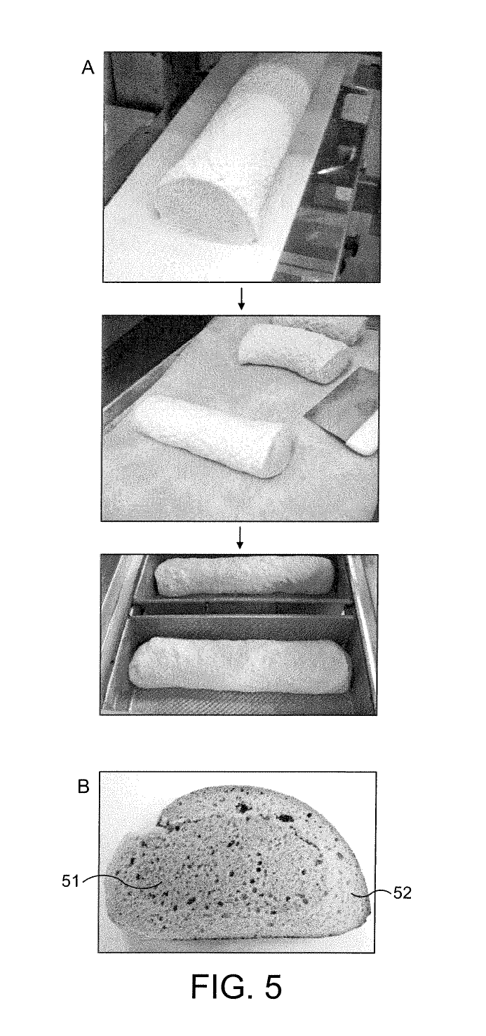

The dough was mixed in a Hobart mixer, rested, formed into balls, relaxed and then formed into loaves. A Rheon was used to co-extrude the two-formula dough (FIG. 5A), using an outer die with a diameter of 60 mm in combination with an inner die having a diameter of 36 mm. The co-extruded product was then cut into suitable length and placed in a pan for 50-55 mins at 85° F., 85% relative humidity (RH). Optionally, a half inch deep slit may be made through the outer dough. Then, the co-extruded product was baked for 22 mins at 350° F., cooled down at room temperature for 2 hrs, stored frozen for a period of time, thawed and finally sliced into ⅝″ slices.

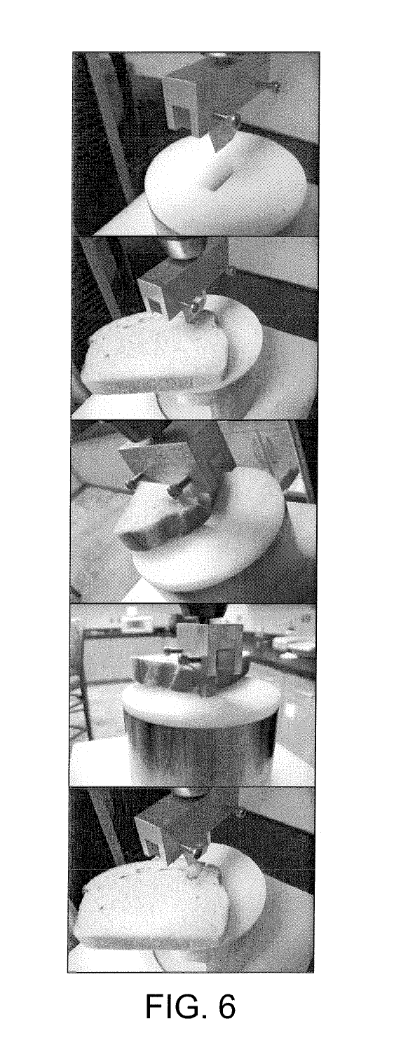

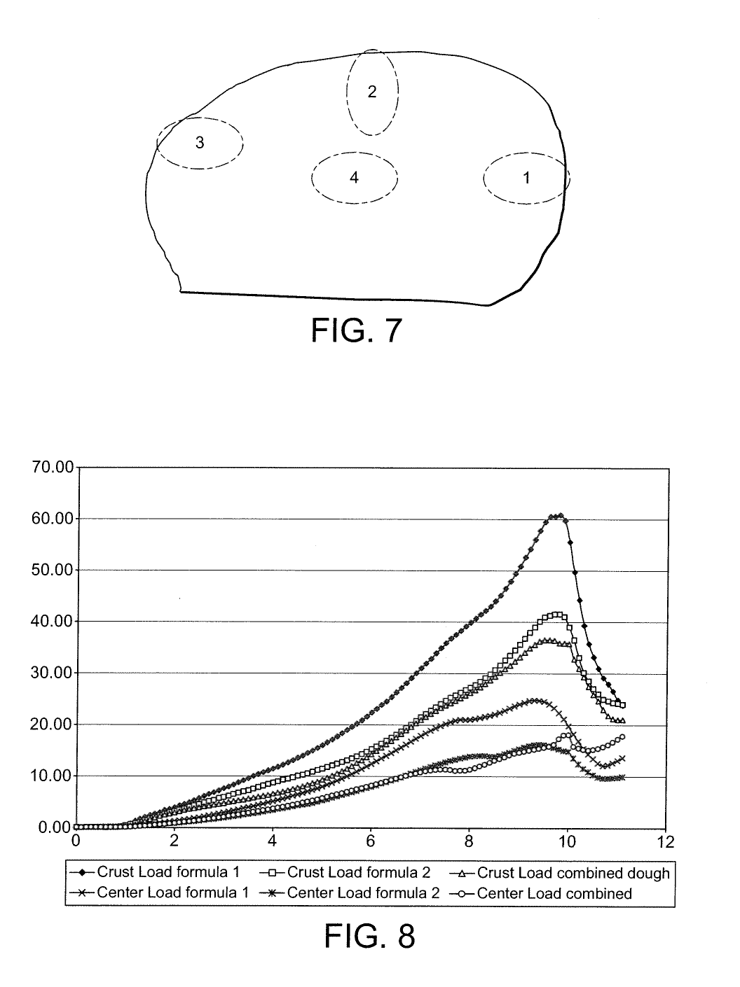

The slices (about 40-45 g each) were then heated, one at a time, in an 1100W microwave oven for 30 sec and allowed to cool for 3 min before the texture was evaluated. FIG. 5B shows the cross-section of a slice of bread, with outer dough 52 surrounding inner dough 51. The texture of the bread was evaluated using an Instron equipped with a plastic knife (width 20 mm) and a platform with an elongated hole (38×8 mm) (FIG. 6). The knife was penetrating the edge or center part of the slices at a speed of 3 mm/sec. The rupture has more the characteristics of tearing than cutting and it has been shown previously that the Max Load (N) correlates with well with toughness as measured by a trained sensory panel. Several measurements were made on each slice (FIG. 7, locations 1, 2, 3 and 4) and several slices were evaluated for each of the samples. The Max Load (N) required to penetrate the bread slice at the given speed was recorded. The measurements from positions 1, 2 and 3 were combined as the crust texture, and measurements from position 4 were combined as the texture of the center part. The average Max Load was used as a measurement of the texture.

As shown in FIG. 8, the crust toughness, as measured by the Instron, differed between the samples. Slices from loaves made up by formula 1 had a higher crust toughness than slices made from formula 2 or loaves with formula 2 as the outer dough (“combined dough” samples). The toughness in the center was much lower than in the crust in all samples, demonstrating the center texture is less sensitive to microwave reheating in that location.

TABLE 2
The average max loads in the different
positions (crust, center) for the three different
varieties (Formula 1, Formula 2, Combined dough)

| | Average Max Load (N) | | |
|---|---|---|---|
| | Formula 1 | Formula 2 | Combined |
| Crust | 63.6 | 42.9 | 38.1 |
| Center | 24.9 | 16.3 | 20.4 |

As shown in Table 2, a combination of two different dough formulations can achieve the benefit of improved texture (reduced crust toughness) and yet incorporate a substantial part of a nutritious whole grain containing dough. The inner part of the slice is not subjected to the same texture effects as the crust part and therefore, the dough making up the inner part can be formulated out of other criteria, such as higher nutritional value and further adaptation to water migration.

### Example Co-Extruded Cookie Dough

Two different dough formulations were combined by co extrusion in Rheon 080808. The dough was either extruded as logs and sliced manually into 50 g cookies, or cut into 50 g pieces automatically by the iris device on the Rheon machine. Baking was done for 40 sec in 1100 W Sharp microwave oven.

The outer dough was formulated for low spread when baked in the microwave for less spread while the inner dough was formulated for more softness/moistness (Table 3)

TABLE 3
Two different dough formulations for co-extruded cookie dough

| | Outer | Inner |
|---|---|---|
| | dough | dough |
| Ingredients | % | % |
| Wheat flour | 35% | 16% |
| Chocolate Chips, Semi-Sweet | | 21% |
| Butter | 23% | 13% |
| Sugar | 29% | 29% |
| Egg yolk powder | 1.1% | 1.0% |
| Molasses | 1.8% | 1.7% |
| Corn Syrup Solids | 1.7% | 1.5% |
| Cocoa Powder | | 4.4% |
| Rice flour | | 1.5% |
| Beet Fiber | | 0.2% |
| Corn starch | 2.5% | 3.2% |
| Emulsifier | | 0.7% |
| Methocel | 0.6% | 0.6% |
| Sodium Bicarbonate | 0.2% | 0.2% |
| Salt | 0.4% | 0.4% |
| Vanilla Flavor | 0.08% | 0.06% |
| Water | balance | balance |
| Total | 100% | 100% |

Both the outer dough and the inner dough contain wheat flour, butter, sucrose, water, egg yolk, molasses, corn syrup solids, starch, methyl cellulose, sodium bicarbonate, salt and vanilla flavor. However, the inner dough contains, in addition, distilled mono-glycerides (0.7%), rice flour (1.5%), beet fiber (0.2%), cocoa powder (4.4%), and chocolate morsels (21%).

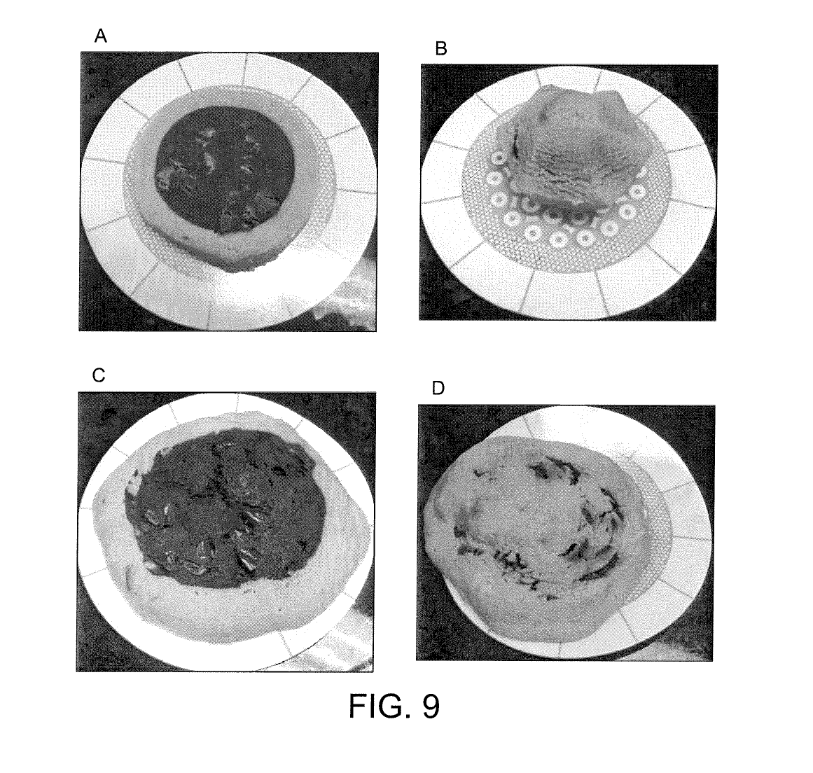

The inner dough formulation was significantly softer and moister after baking in the microwave and spread a lot more when baked unrestricted (FIGS. 9C and D). In contrast, when baked, the co-extruded cookie was restricted from excessive expansion by the low expansion of the outer dough which acted as a container for the more flow-able inner dough (FIGS. 9A and B).

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

1. A method of improving the organoleptic properties of a baked dough product which is to be reheated using microwaves, comprising:
selecting first and second bakery dough portions that are sufficiently viscous to inhibit or avoid miscibility thereof when placed in contact prior to baking, and having properties such that, after being baked, the first bakery dough portion responds differently to microwave reheating as compared to the second bakery dough portion;
providing at least one of the first or second dough portions with a leavening agent and requiring proofing of that dough portion prior to baking;
associating at least a part of the first bakery dough portion with the second bakery dough portion in an unbaked configuration with the dough portions targeted and positioned to provide an improved response of the baked product to microwave reheating;
baking the bakery dough portions in a conventional oven to obtain a bakery dough product; and
packaging the bakery dough product for transport and sale;
wherein the final bakery dough product, after being baked, is uniformly reheated when subjected to heating in a microwave oven due to the differences in responses to microwave heating of the baked dough portions to obtain a baked and reheated dough product for consumption with the product having uniform organoleptic properties compared to dough products that do not utilize such targeted and positioned first and second bakery dough portions.

2. The method of claim 1, comprising co-extruding the first and second bakery dough portions so that the second dough portion surrounds the first dough portion.

3. The method of claim 1, comprising removing the final dough product from the package and reheating the final dough product in a microwave oven or reheating the final dough product in the package and removing the reheated product from the package for consumption.

4. The method of claim 1, comprising:
forming the first bakery dough portion in a generally flat shape having an edge along its perimeter; and
arranging the second dough portion to surround at least a portion of the edge of the first bakery dough portion.

5. The method of claim 4, wherein the first bakery dough portion is formed in a substantially circular or rectangular flat shape and the second dough portion provides a contiguous band in contact with the edge.

6. The method of claim 4, wherein the first bakery dough portion has a substantially cylindrical cross-sectional shape and the second bakery dough portion envelops the first bakery dough portion.

7. The method of claim 1, wherein at least a condition selected from the group consisting of the below is met:
the first bakery dough portion is formulated to be softer than the second bakery dough portion after being baked and subjected to microwave reheating;
the first bakery dough portion is formulated to accept moisture migration without becoming gummy after being baked and subjected to microwave reheating while the second bakery dough portion is formulated to prevent hardening and toughening after being baked and subjected to microwave reheating;
the first and second bakery dough portions are bread doughs and the second dough portion is formulated so as to not form a crust after being baked and subjected to microwave reheating, such that the final bakery product forms a crustless bread after being baked and subjected to microwave reheating; and
one of the first or second bakery dough portion includes one or more ingredient selected from the group consisting of a flour, grain, flavoring agent, coloring agent, textural agent, fiber, and nutrient additive that is not included in the other bakery dough portion.

8. A microwaveable dough product obtainable from the method of claim 1.

9. A baked dough product comprising first and second bakery dough portions that are sufficiently viscous to inhibit or avoid miscibility thereof when in contact prior to baking, but that have properties after baking such that the first bakery dough portion responds differently to microwave heating compared to the second bakery dough portion, with at least a part of the first bakery dough portion associated with the second bakery dough portion and being targeted and positioned to provide an improved response of the baked dough product to microwave heating, wherein the baked dough product after being heated in a microwave oven is uniformly reheated due to the differences in responses to microwave heating of the baked dough portions to obtain a baked and reheated dough product for consumption having uniform organoleptic properties compared to dough products that do not utilize such targeted and positioned first and second bakery dough portions.

10. The baked dough product of claim 9, wherein the first and second bakery dough portions are co-extruded so that the second dough portion surrounds the first dough portion.

11. The baked dough product of claim 9 housed in a package which can be removed so that the final dough product can be reheated in a microwave oven.

12. The baked dough product of claim 9, wherein the first bakery dough portion is in a generally flat shape having an edge along its perimeter; and
the second dough portion surrounds at least a portion of the edge of the first bakery dough portion.

13. The baked dough product of claim 12, wherein the first bakery dough portion is in a substantially circular or rectangular flat shape and the second dough portion provides a contiguous band in contact with the edge.

14. The baked dough product of claim 12, wherein the first bakery dough portion has a substantially cylindrical cross-sectional shape and the second bakery dough portion envelops the first bakery dough portion.

15. The baked dough product of claim 12, comprising a third bakery dough portion that includes a leavening agent and that requires proofing prior to baking, the third bakery dough portion is sufficiently viscous to inhibit or avoid miscibility with the first and second bakery dough portions when in contact therewith, wherein the third bakery dough portion has properties such that, after being baked and subjected to microwave reheating, it responds differently to microwave reheating compared to the first and second bakery dough portions,; and wherein the third bakery dough portion is arranged to surround at least a part of the first or second bakery dough portion to form the unbaked configuration for simultaneous baking of the first, second, and third bakery dough portions to obtain the final baked dough product.

16. The baked dough product of claim 12, wherein:
the first bakery dough portion is formulated to be softer than the second bakery dough portion after being baked and subjected to microwave reheating and a condition selected from the group selected below is met:
the first bakery dough portion is formulated to allow for moisture migration without becoming gummy after being baked and subjected to microwave reheating while the second bakery dough portion is formulated to prevent hardening and toughening after being baked and subjected to microwave reheating;
the dough product is in the form of a crustless bread after being baked and subjected to microwave reheating, wherein the first and second bakery dough portions are bread doughs and the second dough portion is formulated so as to not form a crust after being baked and subjected to microwave reheating; and
the first or second bakery dough portion includes one or more ingredients selected from the group consisting of a flour, grain, flavoring agent, coloring agent, textural agent, fiber, and nutrient additive that is not included in the other bakery dough portion.

17. A method for making a product comprising the steps of using first and second bakery dough portions that have different responses to microwave heating in a bakery dough product that is baked and then is to be subjected to microwave reheating, the dough portions are targeted and positioned to provide an improved response of the baked dough product to microwave heating to obtain a baked and reheated dough product for consumption having uniform organoleptic properties compared to dough products that do not utilize such targeted and positioned first and second bakery dough portions.

18. The method of claim 17, wherein both the first and the second dough portions include a leavening agent and were proofed prior to baking, and wherein the baked dough product after being heated in a microwave oven has uniform texture even though there are differences in responses to microwave heating of the baked dough portions.

19. The method of claim 17, comprising using a third bakery dough portion that responds differently to microwave reheating compared to the first and second bakery dough portions; and wherein the third bakery dough portion is arranged to surround at least a part of the first or second bakery dough portion to form the unbaked configuration for simultaneous baking of the first, second, and third bakery dough portions to obtain the final baked dough product.

20. (canceled)

21. The method of claim 1 comprising forming the first bakery dough portion into a mass having a shape selected from the group consisting of generally circular, oval, crescent, or polygonal cross-sectional shape, and substantially enclosing the first bakery dough portion with the second bakery dough portion.

22. The method of claim 4, wherein the dough product is a pizza dough, with the first bakery dough portion forming a center portion of the pizza dough and the second bakery dough portion forming a perimeter of the pizza dough.

23. The method of claim 6, including enclosing a filling within the first or second bakery dough portions wherein the filling comprises an ingredient selected from the group consisting of meat, chicken, fish, starch, vegetable, nuts, dairy, sauce, spice, and combinations thereof.
